(19) United States
(12) Patent Application Publication
(10) Pub. No.: US 2026/0284867 A1
(43) Pub. Date: Sep. 24, 2026

(54) TOROIDAL ENVELOPING WORM AND HELICAL GEAR TRANSMISSION MECHANISM FOR ROBOT FINGER JOINT, AND ROBOT

(71) Applicant: Talls Intelligent Technology (Shenzhen) Co., Ltd., Shenzhen (CN)

(72) Inventors: Yulong TAO, Shenzhen (CN); Lei TAO, Shenzhen (CN)

(73) Assignee: Talls Intelligent Technology (Shenzhen) Co., Ltd., Shenzhen (CN)

(21) Appl. No.: 19/430,754

(22) Filed: Dec. 23, 2025

(30) Foreign Application Priority Data
Mar. 24, 2025 (CN) 202510349424.7

(51) Int. Cl. B25J 9/10; B25J 17/02; F16H 37/04; F16H 55/08; F16H 57/02; F16H 57/021; F16H 57/039

(52) U.S. Cl. CPC B25J 9/102; B25J 17/0241; F16H 37/04; F16H 55/0846; F16H 57/021; F16H 57/039; F16H 2057/02034; F16H 2057/02073

(57) ABSTRACT

A toroidal enveloping worm and helical gear transmission mechanism for the robot finger joint includes a housing, a toroidal enveloping worm, a helical gear shaft and a drive assembly. The housing is provided with a first accommodating cavity and a second accommodating cavity communicated with the first accommodating cavity, and each of opposite side walls of the second accommodating cavity is provided with a through hole. The toroidal enveloping worm is provided in the first accommodating cavity, and an end of the toroidal enveloping worm is exposed outside the housing. The helical gear shaft is provided in the second accommodating cavity and meshes with the toroidal enveloping worm. Both ends of the helical gear shaft respectively pass through the two through holes, and an axis of the toroidal enveloping worm is perpendicular to an axis of the helical gear shaft.

### CROSS-REFERENCE TO RELATED APPLICATIONS

This application claims priority to Chinese Patent Application No. 202510349424.7, filed on Mar. 24, 2025, the entire contents of which are incorporated herein by reference.

### TECHNICAL FIELD

The present application relates to the technical field of robots, and in particular to toroidal enveloping worm and helical gear transmission mechanism for a robot finger joint, and a robot.

### BACKGROUND

In the field of humanoid robots, the dexterous hand is a key component, and its performance directly affects the overall functionality of the robot. In related art, the finger joints of the dexterous hand are driven by either a rope-driven mechanism or a planetary roller screw drive mechanism. However, rope-driven mechanisms suffer from low precision and short lifespan, making them unsuitable for practical applications. Planetary roller screw drive mechanisms are noisy, bulky, and difficult to integrate.

### SUMMARY

The main purpose of the present application is to provide a toroidal enveloping worm and helical gear transmission mechanism for a robot finger joint, and a robot, aiming to provide a transmission mechanism that is small in size and high in precision.

In order to achieve the above purpose, the present application provides a toroidal enveloping worm and helical gear transmission mechanism for a robot finger joint, including: a housing, a toroidal enveloping worm, a helical gear shaft and a drive assembly;
the housing is provided with a first accommodating cavity and a second accommodating cavity communicated with the first accommodating cavity, and each of two opposite side walls of the second accommodating cavity is provided with a through hole;
the toroidal enveloping worm is provided in the first accommodating cavity, and an end of the toroidal enveloping worm is exposed outside the housing;
the helical gear shaft is provided in the second accommodating cavity, the helical gear shaft meshes with the toroidal enveloping worm, two ends of the helical gear shaft respectively pass through two through holes, and an axis of the toroidal enveloping worm is perpendicular to an axis of the helical gear shaft; and
the drive assembly includes a drive motor and a planetary deceleration structure, and the planetary deceleration structure connects an output shaft of the drive motor to an end of the toroidal enveloping worm exposed outside the housing.

In an embodiment, the toroidal enveloping worm includes a rod body and a plurality of teeth provided at the rod body, and the plurality of teeth form a transmission section; and
the helical gear shaft meshes with the transmission section, and an outer diameter of the teeth gradually increases from a middle portion of the transmission section to both ends of the transmission section.

In an embodiment, the toroidal enveloping worm and helical gear transmission mechanism for the robot finger joint further includes: an eccentric sleeve;
the eccentric sleeve is rotatably provided in the first accommodating cavity, a middle portion of the eccentric sleeve is provided with a through hole, and two ends of the eccentric sleeve are provided with eccentric holes; and
the toroidal enveloping worm is provided in the eccentric sleeve, two ends of t toroidal enveloping worm are respectively rotatably provided in each of the eccentric holes, and a portion of the helical gear shaft passes through the through hole and meshes with the toroidal enveloping worm.

In an embodiment, the eccentric sleeve is provided with a mounting hole communicating with the eccentric hole on a side facing the drive assembly, and an end of the toroidal enveloping worm passes through the mounting hole and is connected to the planetary deceleration structure; and
the toroidal enveloping worm and helical gear transmission mechanism for the robot finger joint further includes a positioning bearing, and the positioning bearing is provided in the mounting hole and sleeved on the toroidal enveloping worm.

In an embodiment, the toroidal enveloping worm and helical gear transmission mechanism for the robot finger joint further includes: two first bearings, the two first bearings are provided in the first accommodating cavity, and the two first bearings are respectively sleeved on two ends of the toroidal enveloping worm.

In an embodiment, the toroidal enveloping worm and helical gear transmission mechanism for the robot finger joint further includes: two second bearings, the two second bearings are provided in the second accommodating cavity, and the two second bearings are respectively sleeved on two ends of the helical gear shaft.

In an embodiment, the drive assembly further includes a drive plate, and the drive plate is electrically connected to the drive motor; and
the housing is provided with an accommodating groove, and the accommodating groove is configured to accommodate a connecting wire of the drive plate.

In an embodiment, the planetary deceleration structure includes a first planetary disk, a second planetary disk, three first planetary gears, three second planetary gears, a first sun gear and a second sun gear; and
a first output rod and three first input rods are respectively provided at both sides of the first planetary disk; the second planetary disk is provided with three second input rods; each of the three first planetary gears is sleeved on a first input rod; each of the three second planetary gears is sleeved on a second input rod; the first sun gear is sleeved on an output shaft of the drive motor and meshes with the three first planetary gears; the second sun gear is sleeved on the first output rod and meshes with the three second planetary gears; and an end of the toroidal enveloping worm exposed outside the housing is limitedly inserted into the second planetary disk.

In an embodiment, a hole wall of the through hole forms an annular mounting groove; and
the toroidal enveloping worm and helical gear transmission mechanism for the robot finger joint further includes two sealing rings, the two sealing rings are respectively sleeved on two ends of the helical gear shaft, and each of the two sealing rings is sealingly embedded in the annular mounting groove.

In an embodiment, a transmission ratio of the toroidal enveloping worm and helical gear transmission mechanism for the robot finger joint is 10:1 to 30:1;
a distance between the axis of the toroidal enveloping worm and the axis of the helical gear shaft is 3 mm to 10 mm; and
a module of the toroidal enveloping worm and a module of the helical gear shaft are both m, wherein 0.15≤m≤0.5.

The present application further provides a robot, and the robot includes the toroidal enveloping worm and helical gear transmission mechanism for the robot finger joint described above.

In the technical solution of the present application, the two ends of the helical gear shaft are connected to the force arm of the robot finger joint. The drive motor drives the toroidal enveloping worm to rotate through a planetary deceleration structure. The toroidal enveloping worm drives the helical gear shaft to rotate, and the helical gear shaft drives the force arm to move, realizing the bending movement of the finger. Furthermore, the flexion and extension of the finger can be controlled through the forward and reverse rotation of the drive motor. The planetary deceleration structure can reduce the high-speed rotation of the drive motor to a lower speed suitable for the movement of the finger joint, while correspondingly increasing the output torque, enabling the finger joint to generate sufficient force for precise motion control.

High-precision transmission control can be achieved through the meshing of the toroidal enveloping worm and helical gear shaft, with low noise and self-locking capability. The first accommodating cavity and the second accommodating cavity in the housing allow the toroidal enveloping worm and the helical gear shaft to be integrated within the housing, resulting in a smaller size, making it suitable for space-constrained robot finger joints.

### BRIEF DESCRIPTION OF THE DRAWINGS

In order to more clearly illustrate the technical solutions in the embodiments of the present application, the drawings used in the description of the embodiments will be briefly introduced below. Obviously, the drawings described below are only some embodiments of the present application. For those skilled in the art, other drawings can be obtained based on the structures shown in these drawings without creative effort.

FIG. 1 is a schematic structural view of a toroidal enveloping worm and helical gear transmission mechanism for a robot finger joint according to an embodiment of the present application.

FIG. 2 is a schematic structural view of the toroidal enveloping worm and helical gear transmission mechanism for the robot finger joint according to another embodiment of the present application.

FIG. 3 is an exploded structural view of the toroidal enveloping worm and helical gear transmission mechanism for the robot finger joint according to an embodiment of the present application.

FIG. 4 is a cross-sectional view of the toroidal enveloping worm and helical gear transmission mechanism for the robot finger joint according to an embodiment of the present application.

FIG. 5 is a cross-sectional view of the toroidal enveloping worm and helical gear transmission mechanism for the robot finger joint according to another embodiment of the present application.

FIG. 6 is a schematic structural view of a toroidal enveloping worm according an embodiment of the present application.

The realization of the purpose, functional characteristics, and advantages of the present application will be further explained in conjunction with embodiments and with reference to the accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by persons skilled in the art based on the embodiments of the present application without creative efforts shall fall within the scope of the present application.

It should be noted that if there are directional indications, such as up, down, left, right, front, back, etc., involved in the embodiments of the present application, the directional indications are only used to explain a certain posture as shown in the accompanying drawings. If the specific posture changes, the directional indication also changes accordingly.

In addition, if there are descriptions related to “first”, “second”, etc. in the embodiments of the present application, the descriptions of “first”, “second”, etc. are only for the purpose of description, and should not be construed as indicating or implying relative importance or implicitly indicating the number of technical features indicated. Thus, a feature delimited with “first”, “second” may expressly or implicitly include at least one of these features. Besides, the meaning of “and/or” appearing in the application includes three parallel scenarios. For example, “A and/or B” includes only A, or only B, or both A and B. In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of the present application.

The present application proposes a toroidal enveloping worm and helical gear transmission mechanism for a robot finger joint 100.

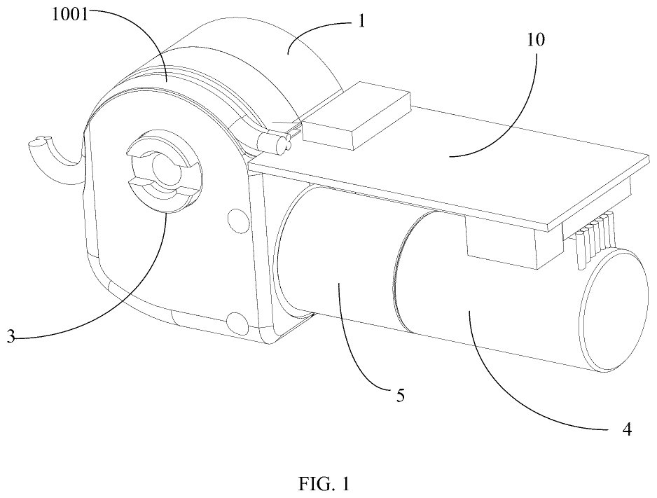

Referring to FIG. 1 to FIG. 3, in an embodiment of the present application, the toroidal enveloping worm and helical gear transmission mechanism for the robot finger joint 100 includes a housing 1, a toroidal enveloping worm 2, a helical gear shaft 3 and a drive assembly. The housing 1 is provided with a first accommodating cavity and a second accommodating cavity communicated with the first accommodating cavity, and each of two opposite side walls of the second accommodating cavity is provided with a through hole. The toroidal enveloping worm 2 is provided in the first accommodating cavity, and an end of the toroidal enveloping worm 2 is exposed outside the housing 1. The helical gear shaft 3 is provided in the second accommodating cavity and meshes with the toroidal enveloping worm 2. Both ends of the helical gear shaft 3 respectively pass through the two through holes, and an axis of the toroidal enveloping worm 2 is perpendicular to an axis of the helical gear shaft 3. The drive assembly includes a drive motor 4 and a planetary deceleration structure 5, and the planetary deceleration structure 5 connects the output shaft of the drive motor 4 to the end of the toroidal enveloping worm 2 exposed outside the housing 1.

The dexterous hand of a humanoid robot will mimic the design of a human hand. Typically, a dexterous hand will have five fingers, each finger will have three joints, and each joint will have one degree of freedom. The toroidal enveloping worm and helical gear transmission mechanism of this embodiment is applied to the robot finger joints. The two ends of the helical gear shaft 3 are connected to the force arms of the robot finger joints. The drive motor 4 drives the toroidal enveloping worm 2 to rotate, and the toroidal enveloping worm 2 drives the helical gear shaft 3 to rotate. The two ends of the helical gear shaft 3 move the force arms to achieve finger bending movements. Furthermore, by driving the drive motor 4 in both forward and reverse directions, the bending and stretching of the fingers can be controlled.

The housing 1 includes two side plates, and two side plates enclose to form a first accommodating cavity and a second accommodating cavity. The two side plates are connected by screws to facilitate the assembly of the transmission mechanism. Specifically, the toroidal enveloping worm 2, helical gear shaft 3 and drive motor 4 can be assembled onto one of the side plates first, and then the two side plates can be connected to complete the assembly.

The axis of the toroidal enveloping worm 2 is perpendicular to the axis of the helical gear shaft 3. As can be seen from the above, the axis of the toroidal enveloping worm 2 will be perpendicular to the robot finger. That is, the drive motor 4 can be perpendicular to the robot finger. Compared the parallel providing to the robot finger, the vertical arrangement enables better installation of the drive motor 4 at the robot finger joint and reduces the installation space required for the toroidal enveloping worm and helical gear transmission mechanism.

The planetary deceleration structure 5 can reduce the high-speed rotation of the drive motor 4 to a lower speed suitable for finger joint movement, while correspondingly increasing the output torque, so that the finger joints can generate enough force for precise motion control.

In the technical solution of the present application, through the meshing transmission between the toroidal enveloping worm 2 and the helical gear shaft 3, high-precision transmission control can be achieved with low noise and self-locking capability. The first accommodating cavity and the second accommodating cavity provided in the housing 1 allow the toroidal enveloping worm 2 and the helical gear shaft 3 to be integrated within the housing 1, resulting in a smaller volume and making it suitable for use in space-constrained areas such as robot finger joints.

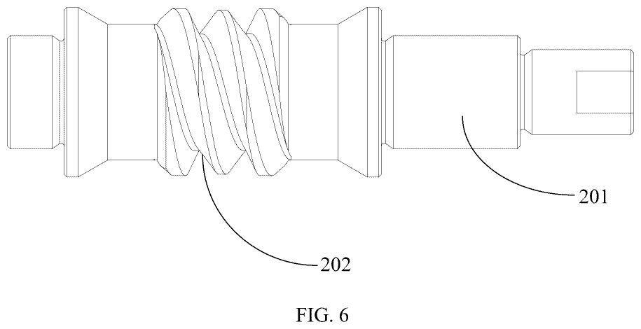

In an embodiment of the present application, referring to FIG. 6, the toroidal enveloping worm 2 includes a rod body 201 and a plurality of teeth 202 provided at the rod body 201. The plurality of teeth 202 form a transmission section, and the helical gear shaft 3 meshes with the transmission section. From the middle portion to both ends of the transmission section, the outer diameter of the teeth 202 gradually increases. That is, the height of the teeth 202 at both ends of the transmission section is greater than the height of the teeth 202 in the middle portion of the transmission section. The plurality of teeth 202 are distributed in a similar arc shape. In this way, when the helical gear shaft 3 meshes with the toroidal enveloping worm 2, multi-tooth meshing can be achieved, thereby generating a larger output torque, thus effectively transmitting the power of the drive motor 4 to the robot finger and improving the robot performance. In addition, by providing the dimensions of the toroidal enveloping worm 2 and the helical gear shaft 3, the toroidal enveloping worm and helical gear transmission mechanism for the robot finger joint can have a self-locking capability, eliminating the need to design an additional locking mechanism.

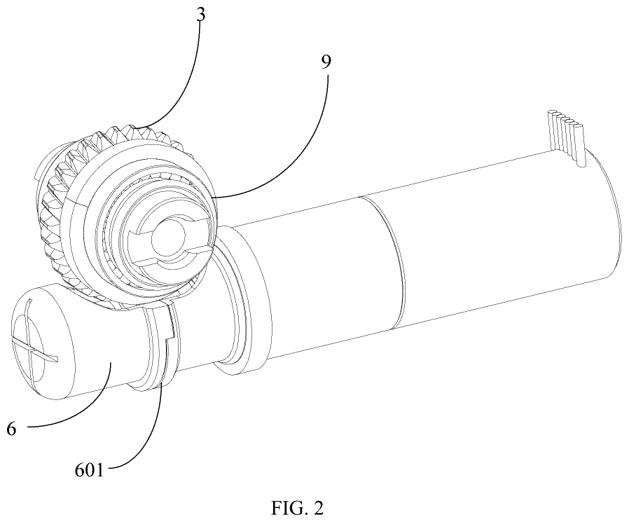

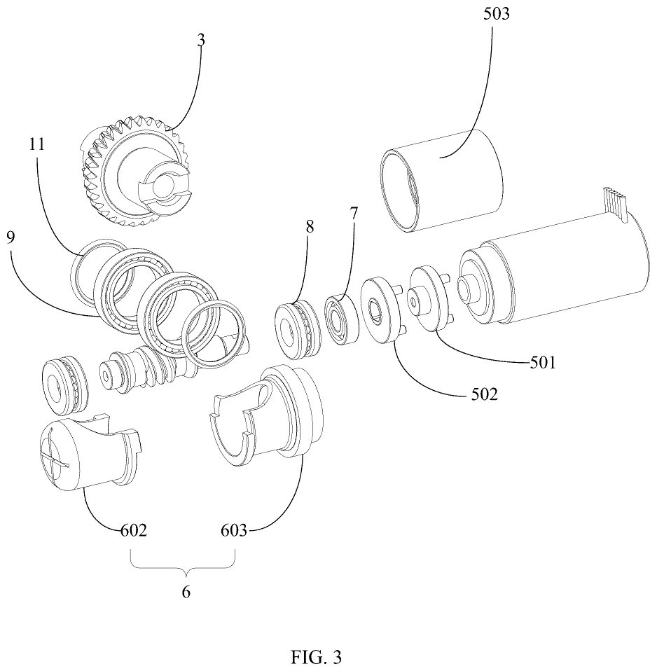

In an embodiment of the present application, referring to FIG. 2, FIG. 3, and F 5, the toroidal enveloping worm and helical gear transmission mechanism for the robot finger joint 100 further includes an eccentric sleeve 6, and the eccentric sleeve 6 is rotatably provided in the first accommodating cavity. A through hole is provided in the middle portion of the eccentric sleeve 6, and eccentric holes are provided at both ends of the eccentric sleeve 6. The toroidal enveloping worm 2 is provided in the eccentric sleeve 6, and two ends of the toroidal enveloping worm 2 are rotatably provided in the eccentric hole. A portion of the helical gear shaft 3 passes through the through hole and meshes with the toroidal enveloping worm 2. It can be understood that the eccentric hole is a hole whose center is not the same as the axis of the eccentric sleeve 6. Thus, by rotating both ends of the toroidal enveloping worm 2 into an eccentric hole, when the eccentric sleeve 6 is rotated, the toroidal enveloping worm 2 will rotate around the axis of the eccentric sleeve 6 under the constraint of the eccentric hole. This changes the distance between the axis of the toroidal enveloping worm 2 and the axis of the helical gear shaft 3, thereby making it suitable for robot fingers of different sizes. In order to facilitate the installation and rotation of the eccentric sleeve 6, the housing 1 is provided with two oppositely provided circular holes communicating with the first accommodating cavity. The eccentric sleeve 6 includes a first sleeve body 602 and a second sleeve body 603, and the first sleeve body 602 and the second sleeve body 603 are spliced together to form the eccentric sleeve 6. The first sleeve body 602 and the second sleeve body 603 are exposed in the housing 1 through the two circular holes respectively. One end of the toroidal enveloping worm 2 passes through the first sleeve body 602 and is connected to the planetary deceleration structure 5. The opposite sides of the end of the second sleeve body 603 exposed in the housing 1 are provided with cross grooves, so that the second sleeve body 603 can be rotated by tools such as screwdrivers, thereby driving the toroidal enveloping worm 2 inside the eccentric sleeve 6 to rotate, so as to change the distance between the axis of the toroidal enveloping worm 2 and the axis of the helical gear shaft 3.

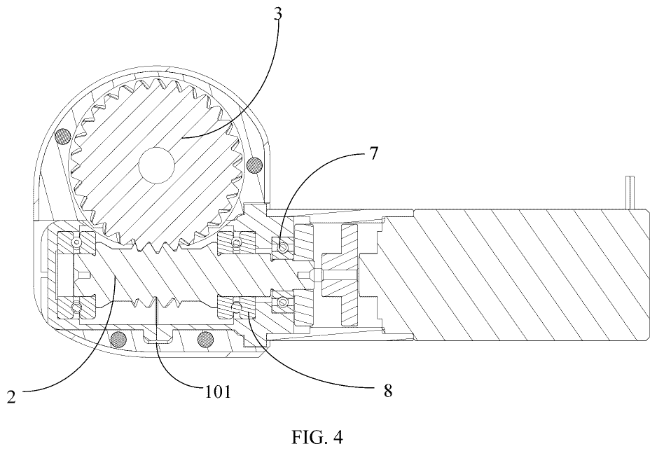

In an embodiment of the present application, referring to FIG. 2 and FIG. 4, an annular groove 101 is formed on the inner wall of the first accommodating cavity. An annular protrusion 601 is formed on the outer wall of the eccentric sleeve 6, and the annular protrusion 601 engages with the annular groove 101. The cooperation between the annular protrusion 601 and the annular groove 101 can provide a mechanical lock, thereby limiting the position of the eccentric sleeve 6 relative to the housing 1. Thus, during the rotation of the eccentric sleeve 6, it can be ensured that the eccentric sleeve 6 will not move relative to the housing 1, and during the rotation of the toroidal enveloping worm 2 driven by the drive motor 4, the eccentric sleeve 6 will not shift.

In an embodiment of the present application, referring to FIG. 3 and FIG. 4, the eccentric sleeve 6 is provided with a mounting hole communicating with the eccentric hole on the side facing the drive assembly. One end of the toroidal enveloping worm 2 passes through the mounting hole and is connected to the planetary deceleration structure 5. The toroidal enveloping worm and helical gear transmission mechanism for the robot finger joint 100 also includes a positioning bearing 7, and the positioning bearing 7 is provided in the mounting hole and sleeved on the toroidal enveloping worm 2. The positioning bearing 7 is provided in the mounting hole and sleeved on the toroidal enveloping worm 2, providing additional support and positioning. This helps to reduce the swaying and deformation of the toroidal enveloping worm 2 when rotating at high speed or bearing large torque, enhances the structural stability of the entire transmission mechanism, and ensures that the finger joint can still operate stably under high load or high precision working conditions.

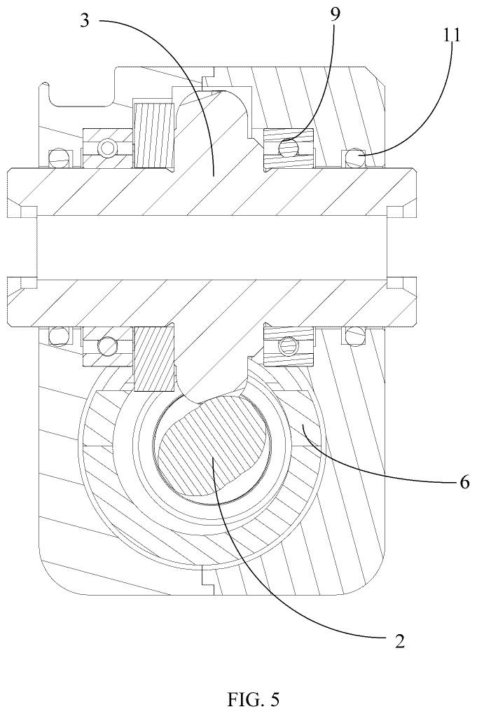

In order to improve service life, in an embodiment of the present application, referring to FIG. 3, FIG. 4, and FIG. 5, the toroidal enveloping worm and helical gear transmission mechanism for the robot finger joint 100 further includes two first bearings 8, and the two first bearings 8 are provided in the first accommodating cavity and respectively sleeved on both ends of the toroidal enveloping worm 2. Similarly, the toroidal enveloping worm and helical gear transmission mechanism for the robot finger joint 100 further includes two second bearings 9, and the two second bearings 9 are provided in the second accommodating cavity and respectively sleeved on both ends of the helical gear shaft 3. The arrangement of the first bearings 8 and the second bearings 9 can reduce the direct contact between the toroidal enveloping worm 2 and the inner wall of the housing 1, and between the helical gear shaft 3 and the inner wall of the housing 1, thereby reducing friction and wear, improving rotational efficiency, and helping to extend service life. The first bearings 8 and the second bearings 9 can also provide stable support points, which helps to maintain the position of the toroidal enveloping worm 2 and the helical gear shaft 3 and ensures stability. When an eccentric sleeve 6 is provided, the first bearings 8 are correspondingly provided in the eccentric sleeve 6.

In an embodiment of the present application, referring to FIG. 1, the drive assembly further includes a drive plate 10, and the drive plate 10 is electrically connected to the drive motor 4. The housing 1 is provided with an accommodating groove, and the accommodating groove is configured to accommodate the connecting wire 1001 of the drive plate 10. The drive plate 10 is electrically connected to the drive motor 4, and the connecting wire 1001 of the drive plate 10 is accommodated by the accommodating groove on the housing 1. This design achieves compact integration of electrical components. Within a limited space, the drive plate 10 and connecting wire 1001 of the drive plate 10 are rationally arranged to avoid cluttered wiring and external interference, making the entire transmission mechanism neater and more orderly, and improving space utilization efficiency.

In an embodiment of the present application, referring to FIG. 3, the planetary deceleration structure 5 includes a first planetary disk 501, a second planetary disk 502, three first planetary gears, three second planetary gears, a first sun gear and a second sun gear. Two sides of the first planetary disk 501 are respectively provided with a first output rod and three first input rods. The second planetary disk 502 is provided with three second input rods. Each of the first planetary gears is sleeved on a first input rod, and each of the second planetary gears is sleeved on a second input rod. The first sun gear is sleeved on the output shaft of the drive motor 4 and meshes with the three first planetary gears. The second sun gear is sleeved on the first output rod and meshes with the three second planetary gears. The end of the toroidal enveloping worm 2 exposed outside the housing 1 is limitedly inserted into the second planetary disk 502. Two-stage reduction is achieved through the meshing of the first sun gear with the three first planetary gears and the meshing of the second sun gear with the three second planetary gears. This multi-stage reduction structure can achieve a large reduction ratio within a small volume, thereby reducing the high-speed rotation of the drive motor 4 to a lower speed suitable for finger joint movements, while significantly increasing the output torque, enabling the finger joints to generate sufficient force for precise motion control. In an embodiment, the planetary deceleration structure 5 further includes a protective housing 503, and the protective housing 503 is connected to the housing 1 and the motor housing. The first planetary disk 501, the second planetary disk 502, three first planetary gears, three second planetary gears, the first sun gear, and the second sun gear are all located within the protective housing 503.

In an embodiment of the present application, referring to FIG. 3 and FIG. 5, an annular mounting groove is formed on the hole wall of the through hole. The toroidal enveloping worm and helical gear transmission mechanism for the robot finger joint 100 further includes two sealing rings 11, the two sealing rings 11 are respectively sleeved on both ends of the helical gear shaft 3, and each of the two sealing rings 11 is sealingly embedded in an annular mounting groove. The sealing rings 11 sleeved on both ends of the helical gear shaft 3, and each of the two sealing rings 11 sealingly embedded in an annular mounting groove, can effectively prevent dust, moisture, or other contaminants from entering the first accommodating cavity, protecting the components from wear or corrosion. In addition, lubricating oil is usually provided in the first accommodating cavity and the second accommodating cavity, and the lubricating oil can provide lubrication for the toroidal enveloping worm 2, the helical gear shaft 3, the first bearing 8, and the second bearing 9. In this case, the provision of sealing rings 11 can also prevent lubricating oil from leaking from the inside, ensuring continuous lubrication of the components and helping to extend the service life of the components.

In an embodiment of the present application, the transmission ratio of the toroidal enveloping worm and gear transmission mechanism for the robot finger joint 100 is 10:1 to 30:1. This high reduction ratio provides precise speed control, thereby ensuring the accuracy of the robot finger's movements. In addition, it also ensures the flexibility and adaptability of the transmission mechanism in different application scenarios.

The distance between the axis of the toroidal enveloping worm 2 and the axis the helical gear shaft 3 is 3 mm to 10 mm. That is, the center distance between the toroidal enveloping worm 2 and the helical gear shaft 3 is 3 mm to 10 mm. By changing the center distance between the toroidal enveloping worm 2 and the helical gear shaft 3, the transmission mechanism can be adapted to robot fingers of different sizes.

The module of the toroidal enveloping worm 2 and the module of the helical g shaft 3 are both m, where 0.15≤m≤0.5. A module within this range can ensure the precision and stability of the transmission mechanism.

The present application also proposes a robot, and the robot includes the above toroidal enveloping worm and gear transmission mechanism for the robot finger joint 100. The specific structure of the toroidal enveloping worm and gear transmission mechanism for the robot finger joint 100 is according to the above embodiments. Since the robot adopts all the technical solutions of all the above embodiments, it has at least all the beneficial effects brought about by the technical solutions of the above embodiments, which will not be described in detail here.

The above description are some embodiments of the present application and does not limit the scope of the present application. Any equivalent structural modifications made using the contents of the specification and drawings of the present application under the technical concept of the present application, or any direct or indirect application in other related technical fields, are included within the scope of the present application.

What is claimed is:

1. A toroidal enveloping worm and helical gear transmission mechanism for a robot finger joint, comprising:
a housing provided with a first accommodating cavity and a second accommodating cavity communicated with the first accommodating cavity, wherein each of two opposite side walls of the second accommodating cavity is provided with a through hole;
a toroidal enveloping worm provided in the first accommodating cavity, wherein an end of the toroidal enveloping worm is exposed outside the housing;
a helical gear shaft provided in the second accommodating cavity, wherein the helical gear shaft meshes with the toroidal enveloping worm, two ends of the helical gear shaft respectively pass through two through holes, and an axis of the toroidal enveloping worm is perpendicular to an axis of the helical gear shaft; and
a drive assembly comprising a drive motor and a planetary deceleration structure, wherein the planetary deceleration structure connects an output shaft of the drive motor to an end of the toroidal enveloping worm exposed outside the housing.

2. The toroidal enveloping worm and helical gear transmission mechanism for the robot finger joint according to claim 1, wherein:
the toroidal enveloping worm comprises a rod body and a plurality of teeth provided at the rod body, and the plurality of teeth form a transmission section; and
the helical gear shaft meshes with the transmission section, and an outer diameter of the teeth gradually increases from a middle portion of the transmission section to both ends of the transmission section.

3. The toroidal enveloping worm and helical gear transmission mechanism for the robot finger joint according to claim 1, further comprising:
an eccentric sleeve;
wherein the eccentric sleeve is rotatably provided in the first accommodating cavity, a middle portion of the eccentric sleeve is provided with a through hole, and two ends of the eccentric sleeve are provided with eccentric holes; and
the toroidal enveloping worm is provided in the eccentric sleeve, two ends of the toroidal enveloping worm are respectively rotatably provided in each of the eccentric holes, and a portion of the helical gear shaft passes through the through hole and meshes with the toroidal enveloping worm.

4. The toroidal enveloping worm and helical gear transmission mechanism for the robot finger joint according to claim 3, wherein:
the eccentric sleeve is provided with a mounting hole communicating with the eccentric hole on a side facing the drive assembly, and an end of the toroidal enveloping worm passes through the mounting hole and is connected to the planetary deceleration structure; and
the toroidal enveloping worm and helical gear transmission mechanism for the robot finger joint further comprises a positioning bearing, and the positioning bearing is provided in the mounting hole and sleeved on the toroidal enveloping worm.

5. The toroidal enveloping worm and helical gear transmission mechanism for the robot finger joint according to claim 1, further comprising:
two first bearings,
wherein the two first bearings are provided in the first accommodating cavity, and the two first bearings are respectively sleeved on two ends of the toroidal enveloping worm.

6. The toroidal enveloping worm and helical gear transmission mechanism for the robot finger joint according to claim 5, further comprising:
two second bearings,
wherein the two second bearings are provided in the second accommodating cavity, and the two second bearings are respectively sleeved on two ends of the helical gear shaft.

7. The toroidal enveloping worm and helical gear transmission mechanism for the robot finger joint according to claim 1, wherein:
the drive assembly further comprises a drive plate, and the drive plate is electrically connected to the drive motor; and
the housing is provided with an accommodating groove, and the accommodating groove is configured to accommodate a connecting wire of the drive plate.

8. The toroidal enveloping worm and helical gear transmission mechanism for the robot finger joint according to claim 1, wherein:
the planetary deceleration structure comprises a first planetary disk, a second planetary disk, three first planetary gears, three second planetary gears, a first sun gear and a second sun gear;
a first output rod and three first input rods are respectively provided at both sides of the first planetary disk;
the second planetary disk is provided with three second input rods;
each of the three first planetary gears is sleeved on a first input rod;
each of the three second planetary gears is sleeved on a second input rod;
the first sun gear is sleeved on an output shaft of the drive motor and meshes with the three first planetary gears;
the second sun gear is sleeved on the first output rod and meshes with the three second planetary gears; and
an end of the toroidal enveloping worm exposed outside the housing is limitedly inserted into the second planetary disk.

9. The toroidal enveloping worm and helical gear transmission mechanism for the robot finger joint according to claim 1, wherein:
a hole wall of the through hole forms an annular mounting groove; and
the toroidal enveloping worm and helical gear transmission mechanism for the robot finger joint further comprises two sealing rings, the two sealing rings are respectively sleeved on two ends of the helical gear shaft, and each of the two sealing rings is sealingly embedded in the annular mounting groove.

10. The toroidal enveloping worm and helical gear transmission mechanism for the robot finger joint according to claim 1, wherein:
a transmission ratio of the toroidal enveloping worm and helical gear transmission mechanism for the robot finger joint is 10:1 to 30:1;
a distance between the axis of the toroidal enveloping worm and the axis of the helical gear shaft is 3 mm to 10 mm; and
a module of the toroidal enveloping worm and a module of the helical gear shaft are both m, wherein 0.15≤m≤0.5.

11. A robot, comprising the toroidal enveloping worm and helical gear transmission mechanism for the robot finger joint according to claim 1.
